(19) United States
(12) Patent Application Publication
(10) Pub. No.: US 2025/0128492 A1
(43) Pub. Date: Apr. 24, 2025

(54) DECORATIVE PANEL

(71) Applicant: CFL Holding Limited, Hong Kong (HK)

(72) Inventors: Thomas Luc Martine BAERT, Sint-Martens-Latem (BE); Tom VAN POYER, Jiaxing (CN); Sven BOON, Jiaxing (CN)

(73) Assignee: CFL Holding Limited, Hong Kong (HK)

(21) Appl. No.: 18/920,221

(22) Filed: Oct. 18, 2024

(30) Foreign Application Priority Data
Oct. 20, 2023 (NL) 2036085

(51) Int. Cl. B32B 3/12; B32B 3/06; B32B 27/10; B32B 27/18; E04F 13/08; E04F 15/02; E04F 15/10; E04F 15/22

(52) U.S. Cl. CPC B32B 3/12; B32B 3/06; B32B 27/10; B32B 27/18; E04F 15/107; E04F 15/22; B32B 2262/10; B32B 2307/536; B32B 2307/54; B32B 2307/546; B32B 2307/706; B32B 2307/72; B32B 2307/7376; B32B 2607/00; E04F 13/0866; E04F 15/02038; E04F 2201/023; E04F 2201/043; E04F 2290/044

(57) ABSTRACT

The invention relates to a panel, in particular a floor, wall, ceiling or building panel, comprising at least one core layer; at least one top layer, in particular at least one decorative top layer; and at least one buffer layer situated between at least one core layer and at least one top layer, wherein at least one buffer layer comprising at least one cellular structure, in particular at least one multicellular structure, and wherein at least one top layer has a modulus of elasticity of at least 1,800 MPa according to EN 310 and/or wherein at least one top layer is flexible around a mandrel having a diameter of 50 mm or larger when tested according to ASTM F137.

### CROSS REFERENCE TO RELATED APPLICATION

This application claims priority under 35 U.S.C. § 119 to Netherlands Patent Application No. 2036085, filed Oct. 20, 2023, which is incorporated herein by reference in its entirety.

### FIELD OF THE INVENTION

The invention relates to a panel, in particular a floor, wall, ceiling or building panel. The invention also relates to a floor covering comprising such panels.

### BACKGROUND

Fall prevention and floor compliance are important topics when considering building materials, especially materials such as decorative flooring, in particular when used in circumstances where it is conceivable that a user or resident might be exposed to situations where a fall is expected to occur. The most common environments associated with fall prevention and compliance are sports venues, but also residential housing, especially for the elderly, disabled, or young children. The consequences of falls can be serious, for example resulting in hip fractures or head injuries, or other physical, psychophysical and/or social consequences. As a direct result, medical costs are incurred, and the risk of early death is increased. According to a UN analysis, it is expected that 30 million people per year are expected to cross age 60 until 2100, reaching a total population of 3 billion 60+years of age, a population in dire need of flooring that is attuned to its specific needs, specifically flooring that is safe, and comfortable to walk upon, without sacrificing aesthetics and performance of state of the art flooring. Conventionally, welfare facilities are designed to include handrails, while steps are eliminated to achieve a barrier-free environment. In addition, there are various known solutions to reduce the risk of injury resulting from falls. It is known to provide devices, such as pads, that are worn on specific areas of the body, such as the hip, to absorb the impact or shock from a fall and reduce the risk of a fracture. However, such devices will protect only the area of the body that is covered. Other body parts that remain uncovered, such as wrists, are not protected from impact during a fall.

As a solution, impact absorbing systems have been proposed, with the purpose of preventing an injury by reducing the impact caused by a fall. Known impact absorbing systems include among others compliant floors, rubber floors, and sports floor coverings which are flexible and typically made of rubber or flexible homogeneous vinyl. It is known to install these types of floors in combination with a closed-cell foam, vulcanized rubber chips or an array of deformable elastomeric cells under an elastomeric and/or flexible surface layer, to provide a shock absorbing structure. However, the combination of elastomeric and/or flexible surface layers with deformable materials such as foams typically provide dangerous point-impact surface deformation levels and fail to adequately protect against injuries from serious or ‘bottoming-out’ impacts. As a result, structures comprising a foam layer might deform or could even be displaced by axial impact forces such as hip, elbow, or head impacts, or even just by prolonged standing. The foam layer may be compressed too much at one point, directing most of the impact directly to the subfloor, which is not typically designed to absorb shocks and thus may not provide the necessary cushioning needed to protect an individual from injury. These factors can be of even greater concern in nursing homes and welfare facilities where many residents may have an unsteady gait or utilize wheelchairs.

In addition to abovementioned disadvantages, most impact absorbing systems, in particular rubber floors and sports floor coverings are thick, heavy, difficult to install, and require professional installation. Such types of floors require a lot of time to install in large spaces and can be cumbersome to install in smaller spaces as the material used therein is difficult to manipulate. In some cases, the surface of such type of floor may not be completely seamless and will contain grooves or other imperfections. Lastly, due to their size, such systems are not aesthetically pleasing.

In view of the foregoing limitations of conventional systems, there is therefore a need for an easy to install hard surface floor covering that remains relatively rigid or is structurally stable under normal usage conditions, thereby allowing the use of for example wheelchairs and that does not impede regular use, does not show point deformation but rather area elastic deformation, is compliant, cushions the body and absorbs a significant amount of impact when a fall does happen.

The invention provides thereto a panel, in particular a decorative panel, more in particular a floor, wall, ceiling or building panel, comprising:
at least one core layer;
at least one top layer, in particular at least one decorative top layer; and
at least one buffer layer situated between at least one core layer and at least one top layer,
wherein at least one buffer layer comprising at least one cellular structure, in particular at least one multicellular structure, and
wherein at least one top layer has a modulus of elasticity of at least 1,800 MPa according to EN 310 and/or wherein at least one top layer is flexible around a mandrel having a diameter of 50-350 mm when tested according to ASTM F137 or has a flexibility of 50 mm-350 mm in a Mandrel test according to ASTM F137.

### DETAILED DESCRIPTION

The panel according to the present invention has a well-balanced combination of rigidity and compliance. Due to the combination of the semi-rigid top layer and the buffer layer according to the present invention, the panel can absorb impact forces to a certain degree, especially when used as a floor panel. Upon impact from a falling individual or object, the kinetic energy imparted to the panel is initially distributed onto an area of the top layer and then transferred to the buffer layer, where the kinetic energy is then converted to internal energy within the structure of the buffer layer. In this manner, the kinetic energy upon impact to the panel is fractionally dissipated from the surface of the semi-rigid top layer and throughout its volume before being transferred to the at least one buffer layer. Subsequently, upon transfer of kinetic energy to the at least one buffer layer, its structure rearranges or compresses further redistributing the impact force throughout its structure and at the same time absorbing a significant amount of kinetic energy within the structure such that the kinetic energy restored during impact is significantly minimized. As a result, energy restitution of the panel is significantly improved through the combination of the top layer and the buffer layer. Consequently, the individuals/objects falling during impact are protected from injury or damage and at the same time, the panel is protected from permanent deformation. Furthermore, due to the buffer layer being compressible/collapsible, the time dependent response thereof during impact allows the at least one semi-rigid top layer to be deformable to a certain extent when impact forces are exerted thereon. Unlike conventional impact absorbing solutions, such as point elastic surfaces, where the kinetic energy from impact of a falling individual is absorbed only at the point of impact and is dissipated for a short period of time, the panel of the present invention comprises a layered impact absorption system that is found to effectively spread out the kinetic energy on a larger surface rather than being concentrated in one point. In addition, the layered impact absorption system of the present invention is configured to dissipate the energy from impact for a longer period thereby ensuring optimal energy absorption. More specifically, the layered impact absorption system comprises a semi-rigid top layer and at least one buffer layer that synergistically augment each other's functions in order to absorb and mitigate impact forces. The semi-rigid top layer efficiently transfers energy from the point of impact to a broader area of the panel, more specifically the at least one buffer layer. The semi-rigid top layer prevents the concentration of force on a single point and diffuses this force/energy throughout the panel of the present invention. The at least one buffer layer then functions to compress/deform such that the energy from impact is dispersed and localized pressure exerted on any specific body part upon impact is significantly minimized. This synergetic function of the at least one buffer layer combined with the top layer according to the invention can be referred as bulk compression. This function of the at least one buffer layer diminishes peak forces and gradually decelerates an individual's body upon impact thereby augmenting the dissipation of energy on the semi-rigid top layer and consequently reduces the risk of injuries.

The combination of the top layer and the buffer layer according to the present invention allows the top layer and the panel in whole to act as a cushion that receives the force imparted by a falling individual or object while also allowing the floor panel to be sufficiently rigid to allow, optionally, the placement of an interlocking mechanism thereon. The combination of a semi-rigid top layer and a buffer layer also improves the compressive strength of the (floor) panel and consequently improves the flexural modulus and bending failure load thereof, such that impact forces and impact energy are minimized efficiently and gradually upon contact with the floor panel surface. Such a decrease reduces the risk of injury and provides better impact protection to individuals or objects that fall into contact with a floor formed of panels according to the present invention. With the panel having a semi-rigid, preferably decorative top layer and at least one buffer layer, in particular a collapsible, buckling-oriented and/or compactible buffer layer, the comfort of walking on floor panels according to the present invention is further improved. As a result, the panel according to the present invention aids individuals who have physical difficulties, such as those who have rheumatoid arthritis and the like, in moving around with physical ease and/or lessened pain or constraint, while providing sufficient support to withstand point deformation such as from chair legs, table legs, high heels, wheelchairs and the like.

The panel according to the present invention comprises at least one buffer layer. As used herein, the buffer layer provides at least one means of attenuating vibrations produced by the impact of axial impact forces, axial physical forces and/or soundwaves or oscillations, via compression, collapse, compacting, absorption, decoupling or isolation, or combinations thereof. In some embodiments, at least one buffer layer comprises at least partially a material that buckles when exposed to impact or load forces. The buffer layer can then be referred to as a compression or compressible layer, collapsible layer, compactable layer, shock absorbing layer, decoupling layer or layer with decoupling elements, isolation layer, deformable layer, buckling oriented or architected material, or combinations thereof. The use of at least one buffer layer situated between at least one core layer and at least one top layer reduces the stiffness of the ground underneath the panel due to the compressible characteristics of the buffer layer, if applied as floor panel. The at least one buffer layer typically provides optimum flexibility which causes a considerable attenuation to the impact forces during the fall. In addition to that, it also reduces the amplitude of certain frequencies of sound waves that pass through the floor, wall, ceiling, or a building panel and absorbs some of the acoustic energy. A further benefit of the use of at least one buffer layer is that it contributes to make the panel adapt to subfloor irregularities.

It is imaginable that at least one buffer layer is attached to the upper surface of at least one core layer. It is for example possible that at least one buffer layer is attached to the upper surface of at least one core layer by means of an adhesive and/or glue. It is also possible that at least one buffer layer is attached to the bottom surface of at least one (decorative) top layer. It is for example possible that at least one buffer layer is attached to the bottom surface of at least one (decorative) top layer by means of an adhesive and/or glue. It is also imaginable that at least one buffer layer functions as core layer of the panel.

It is conceivable that at least one buffer layer is typified by a threshold-activated constant-force response, which comprises an initial elastic deformation in a first time period, where the buffer layer may absorb at least some kinetic energy and displace without offering strong resistance, wherein the force may increase gradually as the displacement increases up to a certain threshold and/or displacement threshold, expressed in mm. It is conceivable that beyond said certain displacement threshold, the at least one buffer layer may exhibit a stiffer response, transition to a plastic deformation, and/or transition from elastic to more inelastic behaviour in a second phase. It is conceivable that during said second phase, the buffer layer resists further displacement with a relatively constant force, wherein the slope of the force-displacement curve is relatively flat, indicating that the stiffness is not rapidly increasing, in effect reducing the abruptness of the impact force, and/or gradually reducing the impact force. It is conceivable that said displacement threshold or yield point is accompanied by the peak force or Fmax experienced during the impact. It is also conceivable and preferable that the yield point is lower than the peak force or Fmax experienced during the impact, which may also be achieved during a third compacting phase, which is preferable. It is surmised that such threshold-activated constant-force response is advantageous in case the panel is a floor panel, as it provides a more gradual deceleration during an impact, reducing or at least delaying the peak force (Fmax=Max (F (displacement))) and the maximum acceleration (Gmax=Max (a (time)) wherein a (time)=the acceleration at a specific time point or during a time frame during the impact) experienced by a person falling. Said response advantageously dissipates the kinetic energy of the impact over a longer distance and time, which can reduce the risk of injury, while maintaining a sufficiently high threshold or yield point to support regular use of said flooring, even when exposed to heavy foot traffic. The threshold or yield point is then understood to be the max force or weight per surface area that can be safely exerted on such a floor in daily use, beyond which the surface transitions into a safety floor designed to buckle and reduce the maximum acceleration exerted on a falling person.

At least one buffer layer preferably comprises at least one multicellular structure chosen from the group of a honeycomb structure, a twinwall structure, a corflute construction, a foamed structure, a lattice structure, or combinations thereof. In a possible embodiment, at least one buffer layer comprises at least one cellular structured layer. It is conceivable that the cellular structure layer is a multicellular structure which comprises a plurality of cellular structures, which preferably has the same intended function as the buffer layer. In another preferred embodiment, at least one buffer layer comprises at least one multicellular structured layer that is chosen from the group consisting of an open-cell, closed-cell, honeycomb structure, a foamed layer, a lattice structure, or combinations thereof. The multicellular structure comprises for example a 2.5 dimensional or planar architected material or a 3-dimensional architected material. A 2.5 dimensional or planar architected material is conceived as comprising at least one two-dimensional shape thermoformed and/or extruded into a third direction to create a three-dimensional structure. By having a 2.5-dimensional lattice configuration, the multicellular structure of the buffer layer can be formed by a plurality of folding points and a plurality of cell walls or struts that are repeated at least once in at least one axis. At least one buffer layer could for example comprise at least one multicellular structure comprising a 2.5-dimensional architected material, preferably a 2.5-dimensional continuous lattice configuration formed by n folding points, or joints, and p cell walls repeated at least once in at least one axis. The multicellular structure of at least one layer being 3-dimensional can also be formed by a plurality of nodes and a plurality of cell walls or struts repeated at least once in at least 2 axes. It is also conceivable that at least one buffer layer comprises at least one multicellular structure comprising a 3-dimensional architected material, preferably a 3-dimensional lattice configuration formed by n nodes and p struts repeated at least once in at least 2 axes. The 2.5-dimensional and/or 3-dimensional architected material can be chosen from the group of a hexagonal lattice structure, origami structure, folded structure and/or pentamode metamaterials. It is also imaginable that at least part of the struts and/or cell walls comprise at least one folding point, or joint, or possibly multiple folding points, or joints. In some configurations, the plurality of struts or cell walls comprise at least one folding point. At least one folding point could also refer to as node, joint or hinge.

In a preferred embodiment, at least part, preferably most of the struts and/or cell walls are substantially oblique, in particular the struts and/or cell walls are in a 30-60 degrees orientation, with respect to the expected direction of the impact force, to avoid the architecture or system to exhibit inertial effects and to allow said architecture to exhibit a strain-rate sensitivity. By following this configuration, the impact force is dissipated in the structure in a preferred manner that enhances the safety features of the panel. At least 20%, preferably at least 40%, more preferably at least 60% of the struts and/or cell walls, are oblique to a direction of an impact force and/or a direction perpendicular to the at least one upper surface of the panel.

At least one buffer layer could also comprise at least one cellular structure comprising an array of spatial periodic unit cells with interconnected edges and faces and/or interconnected struts and nodes. Optionally, at least one buffer layer could comprise at least one cellular structure comprising a plurality of unit cells that form at least partially a porous and/or hollow structure.

The cellular structure of at least one buffer layer may impart springiness to at least one top layer. The cellular structure of at least one buffer layer is preferably configured to flex and thus reduce forces during impact from a falling individual or object in particular in case the panel is applied in flooring. Typically, the semi-rigid top layer spreads out the energy from an impact to its surface and gradually dissipates said energy on the top layer before said energy is transferred to the at least one cellular structure of the at least one buffer layer. The energy is then dissipated in a controlled manner through the at least one cellular structure such that optimum absorption of said energy is achieved within the at least one buffer layer. This results to an improved energy restitution in the panel as the energy returned as a percentage of the energy applied during impact is relevantly decreased. Consequently, risk of injury during impact of a falling individual or damage to a falling object is reduced. On the other hand, ease of movement on the floor is improved thereby providing more comfort specially to individuals who have physical difficulties.

It is imaginable that at least one buffer layer comprises a composite architecture comprising a combination of at least one honeycomb, at least one foamed structure and/or at least one lattice structure. It is imaginable that at least part of at least one cellular structure of at least one buffer layer defines a honeycomb structure, a bubble guard sheet, a corrugated sheet, a corflute construction and/or a twinwall structure. At least part of at least one support structure defining any of said structures can further benefit to the strength and/or rigidity of the panel. It is for example imaginable that the walls defining the honeycomb structure, a bubble guard sheet, a corrugated sheet, a corflute construction and/or twinwall structure extend over the thickness of the buffer layer. It is also imaginable that the walls defining the honeycomb structure, a bubble guard sheet, a corrugated sheet, a corflute construction and/or twinwall structure extend under an angle, and in particular substantially perpendicular with respect to a plane defined by the front surface and/or back surface of the panel, and in particular the buffer layer. The honeycomb structure can for example be a buckling-oriented thermoplastic honeycomb structure. Yet a further embodiment is conceivable wherein the panel comprises at least one additional buffer layer or secondary buffer layer. At least one secondary buffer layer can be a separate layer additional to at least one core layer. It is also imaginable that at least one secondary buffer layer is disposed proximally to the at least one core layer and/or forms part of at least one core layer. At least one secondary buffer layer can be defined as any of the described embodiments of the buffer layer according to the present invention. A further embodiment is conceivable, wherein at least part of at least one cellular structure of at least one buffer layer defines a grid. The cellular structure of at least one buffer layer preferably extends over the entire buffer layer. Hence, it is imaginable that the cellular structure defining a grid extends over the entire buffer layer. At least part of the cellular structure of at least one buffer layer can be filled with at least one multicellular material.

At least one buffer layer possibly comprises at least one cellular structure comprising a gradient structure. It is for example possible that at least one cellular structure comprises a gradient discrete structure, a gradient increasing structure and/or gradient decreasing structure defined over the thickness of the buffer layer.

It is also conceivable that the at least one cellular structure can form a random structure where the unit cells have different sizes (i.e. Voronoi-tessellation structure), a non-uniform structure and/or a periodic structure. It is conceivable that the non-uniform structure forms a gradient structure, in particular a gradient discrete (i.e. low-high-low, high-low-high), gradient increasing (i.e. from low to high), gradient decreasing (i.e. from high to low), or combinations thereof that exhibits the desired effect of force reduction during impact and/or improve the impact force dissipation resulting to a safer floor or building panel.

In a preferred embodiment, at least one buffer layer comprises at least one metamaterial, which can impart excellent mechanical strength and impact energy absorption ability to the building panel. Preferably, the at least one metamaterial used in the buffer layer or, in some cases, in any part of the panel is a composite material or composite media that are made up of micro or nanoparticle building blocks having repetitive patterns to interact with soundwaves or external forces such as compression or impact to produce beneficial effects such as sound attenuation, shock absorption, impact reduction, or combinations thereof. At least one metamaterial is preferably a material chosen from the group consisting of liquid crystal elastomers (LCE), foam-based LCE, high-energy absorbing LCE, shell lattice (SL) metamaterials, bending-dominated metamaterials, stretching-dominated metamaterials, octet lattice materials, truss lattice materials, shellular materials, sonoblind, or combinations thereof. In a possible embodiment, the at least one metamaterial relies on the geometry of their subunits to effectively function as a shock absorption or cushioning material. In this case, the metamaterials that can be used are classified into auxetic metamaterials such as re-entrant structure, 3D buckyball, fiber network mats, crystalline rolled-up tubes; pentamode metamaterials such as pentamode structure and Kagome structure; pattern transformation such as Holey sheets and Biholar sheets; cellular origami such as stacked miuri-ori and interleaved miuri-ori; origami metamaterials such as miura-ori tessellated pattern, non-periodic Ron Resch pattern, square twist, and kirigami; chiral systems such as trichirals, tetrachirals, and hexachirals; micro-/nanolattices such as stretch-dominated octet-truss and bend-dominated tetrakaidecahedron; and/or combinations thereof. By using at least one metamaterial in at least one buffer layer, the mechanical properties leading to shock absorption and/or cushioning effect can be modified for optimal performance. Such properties include the metamaterial or the buffer layer's stiffness, rigidity, and compressibility that are dependent on the Poisson's ratios, shear/bulk modulus, Young's modulus, or combinations thereof. In a preferred embodiment, at least one metamaterial that forms at least a part of at least one buffer layer is produced via subtractive manufacturing and/or additive manufacturing (AM) such as selective laser melting (SLM), or combinations thereof. These manufacturing methods allow the fabrication of strong and lightweight structures with geometry that is complex for traditional manufacturing methods.

It is conceivable and preferable according to the invention that at least part of the buffer layer comprises an architected material that comprises at least partially an anisotropic structure. It is conceived that said anisotropic structure exhibits distinct physical properties according to the axis it is measured, for example rigidity, indentation resistance, compliance, expansion and/or swelling, which could provide asymmetrical characteristics to at least part of the panel, such as a high strength in a horizontal plane, and a high flexibility or compliance in a vertical plane, which may be particularly advantageous when combined with an interlocking mechanism, while still able to absorb impact forces.

The panel could also comprise multiple buffer layers each comprising at least one cellular structure, in particular at least one multicellular structure. If such embodiment is applied, it is preferred that the compressibility of at least one first buffer layer is larger than the compressibility of at least one second buffer layer. The compressibility of at least one first buffer layer situated between a second buffer layer and at least one top layer can for example have a higher compressibility than the compressibility of at least one second buffer layer.

In a preferred embodiment, at least part of the cellular structure of at least one buffer layer could for example have a repeated pattern or any polygon or n-gon matrices. The cellular structure may define a matrix which could result in the presence of hollow portions and/or cavities within the cellular structure thus forming a porous multicellular-structured layer. In such case, it is imaginable that at least part of the hollow portions and/or cavities are filled with at least one filler. The use of fillers inside these hollow portions could further increase the cushioning effect thus achieving a more comfortable and safer floor. Non-limiting examples of filler materials are foam pellets, expanded polymers, expanded polystyrene (EPS) or Styrofoam, expanded polypropylene, memory foam, micro/nano beads, foam fillings, polyvinyl (PVC) pellets, soft filler materials, or combinations thereof. In another example, the at least one cellular-structured layer comprises a matrix structure. It is for example possible that at least part of at least one cellular-structured layer comprises a honeycomb structure and/or any polygon or n-gon matrices. The use of such configuration could positively contribute to the force distribution upon impact.

It is also conceivable that at least one buffer layer is formed by or comprises a gel and/or gel layer. At least one cellular structure of at least one buffer layer could also be formed by or comprise at least partially a gel layer. Such gel layer can for example be a substantially sticky gel layer. This could keep the gel layer in position, possibly without the interference of an adhesive. At least one gel layer can for example be a gel mat or gel pad. The gel layer could for example comprise silicon and/or polyurethane.

At least one buffer layer could have a Shore A hardness of 75 or less, preferably a Shore A hardness of 65 or less, more preferably a Shore A hardness of 55 or less. The Shore A hardness of at least one buffer layer may for example be in the range of 45 to 65. In an advantageous embodiment, the Shore A hardness of at least one buffer layer is at most 55. At least one buffer layer having a Shore A hardness of 75 or less is typically configured to be temporarily deformed, and in particular compressed. It has been found that such range of values for Shore A hardness showcases the most desirable performance in mitigating the impact pressure and further absorbing the energy transferred from the decorative top layer The at least one buffer layer or the at least one cellular-structured layer will have in general a positive effect on the impact absorption and sound attenuation of the panel.

The compressive strength of at least one buffer layer can be measured according to EN 826. The compressive strength is an indication of the ability of a material to deform locally at a point of pressure when a perpendicular force is applied to its surface. A Shore A hardness of 75 is according to this test method roughly equivalent to 445 psi or 3 Mpa. Preferably, at least one buffer layer has a compressive strength of 400 kPa or less, and more preferably of 200 kPa or less. The at least one buffer layer having a compressive strength of 200 kPa or less allows deformation and is able to revert to its original state relatively quickly after being subjected to stress. The use of such at least one buffer layer can further contribute to the absorption and/or transformation of the impact's kinetic energy where for a significant reduction in the generated sound's amplitude and pitch can be achieved. It was experimentally found that good results were achieved when applying such buffer layer. It is also imaginable that at least one buffer layer has a memory effect upon indentation.

It is conceivable that the at least one cellular structure or multicellular structure comprises or forms a mostly hollow structure which effectively dissipates and absorbs energy upon impact, aside from minimizing damage and reducing the risk of injury. It is conceivable such structure comprises large pore constructs, such as perforations, and/or smaller pore sizes to augment the dissipation of kinetic energy resulting from impact. Such construction of the buffer layer may capture or reverberate sound waves much more efficiently, acting as an energy-trapping barrier or noise barrier that confines the energy and/or waves within a volume between a rigid boundary and a reflecting surface. The at least one buffer layer is conceived to reduce the strength of kinetic energy of an impact from a fall and the amplitude of sound waves reflecting from it. Said kinetic energy and/or sound waves superimpose with the kinetic energy and/or sound waves coming to the panel and generate a resonance effect therein, thus the resonance effect decreases as well. Further, the surface of the at least one buffer layer facing the incoming impact and/or sound waves effectively dissipates the energy and/or absorbs low frequencies of sound waves to control the directions of the multiple reflections of the sound waves. The mechanical energy resulting from impact and/or sound waves that penetrate the perforations of the macro-structured layer allow energy dissipation, sound damping, reflection, and friction as the mechanical kinetic energy propagate through the pores of the material, wherein dissipation and/or sound absorption is achieved.

It is further conceivable that the at least one buffer layer comprises at least two cellular structures It is also conceivable that an intermediate layer is disposed in between at least two cellular-structured layers. Preferably, the said intermediate layer acts as a conduit or a means for coupling the at least one cellular structured layer.

In another embodiment of the present disclosure, the cellular-structured layer comprises an array of perforations and is sandwiched between two cellular-structured layers, to completely decouple said layers such that said perforation array augments the dissipation of kinetic energy and aids the impedance of the vibrations of incident sound waves traversing the depth of the perforation array due to the significant differences in the densities of materials. It is likewise possible that a mass-air or a mass-air-mass structure is formed from this configuration, which may likewise result in the reduction of impact from a fall and the impedance of incident sound waves across wall panels.

The density of at least one buffer layer or the at least one cellular structure thereof is typically lower than the density of the top layer. It is for example conceivable that the density of at least one buffer layer is at least 50% less, preferably at least 70% less, more preferably at least 90% less than the density of the top layer. With such difference in the densities of the at least one buffer layer and the top layer, an optimal combination of sufficient structural stiffness resulting from a higher density in the top layer and an average low density in the buffer layer is achieved. As a result, the impact sensitivity at the at least one top layer is optimized. At least one buffer layer possibly has an average density in the range of 25 kg/m3 and 350 kg/m3. It is conceivable that the at least one buffer layer has a density of at least 25 kg/m3 and/or at most 350 kg/m3. The density of at least one buffer layer could for example be at least 60 kg/m3 to 300 kg/m3, preferably at least 60 kg/m3 to 275 kg/m3. It has been experimentally found that at densities lower than 25 kg/m3, the energy dissipation ability of the at least one buffer layer is decreased and that the range of density from at least about 25 kg/m3 to 350 kg/m3 exhibit the most desirable performance.

At least one buffer layer preferably has a thickness of in the range of 1 to 8 mm, for example in the range of 3 to 7 mm. At least one buffer layer or the at least one cellular structure thereof possibly has a thickness which is less than the thickness of the at least one top layer and/or at least one top layer. Alternatively, it is also imaginable that the thickness of at least one buffer layer is larger than the thickness of a least one decorative layer and/or core layer. Partially depending on the materials applied, the thickness of at least one cellular structure of at least one buffer layer with respect to the top layer ensures that the top layer is not overly stiff such that the springiness of the cellular structure is subdued. At least one buffer layer or the at least one cellular structured thereof has a thickness in the range of 0.8 to 3 mm, preferably in the range of 1.2 to 2 mm. It is also possible that at least one cellular structure and/or at least one buffer layer has a thickness in the range of 0.5 mm to 2 mm, preferably in the range of 0.75 mm to 1.5 mm.

In a possible embodiment, at least one buffer layer comprises at least one cellular structure that is configured to buckle, collapse and/or compact when exposed to axial impact or load forces. The at least one cellular structure exhibits a compressive performance resulting to superior impact absorption performance as manifested by an observed lower Gmax and lower HIC compared to conventional panels. The compressive performance of the at least one cellular structure can be attributed to the bending-dominated behaviour of the structure which allows the at least one cellular structure, during an elastic and/or plastic deformation phase, to gradually dissipate the initial force or acceleration experienced by an individual or an object during impact. It has been experimentally found that the at least one cellular structure of the buffer layer effectively absorbs impact at a first time period in an elastic manner up to a certain yield point, and then subsequently dissipates the remainder of the impact within the layer at a second time period ensuring that the remainder of the impact is absorbed at a sustained rate. As a result, energy restitution in the panel is substantially improved and the energy returned by the panel in comparison to the energy applied during impact by an individual or an object to the panel is reduced thereby minimizing risk of injury or damage to the individual or object. Evidently, the at least one cellular structure of the buffer layer showcases an effectively equilibrized inertial sensitivity and strain-rate sensitivity such that the panel of the present invention exhibits sustained deformation. It is conceivable that at least one cellular structure exhibits at least an elastic deformation during a first time period, a plastic deformation during a second time period, and/or a densification stage during a third time period when compressed by an out of plane load or force. During said first time period or elastic deformation stage, the buffer layer's response may be linear up to an elastic limit, yield point and/or threshold displacement, after which it is conceivable the buckling, compacting and/or collapsing of the buffer layer is typified by a plastic deformation during said second time period. It is preferable that this plastic deformation stage is typified by a near constant force-displacement curve. Once the buffer layer deforms enough that contact with other components occurs, constraining further deformation, a densification deformation phase is reached during a third time period.

In a preferred embodiment, the at least one cellular structure of the buffer layer is specifically designed to exhibit at least an elastic deformation during a first time period, a plastic deformation during a second time period, and/or a densification stage during a third time period when compressed by an out of plane load or force. As such, it is conceivable that the at least one cellular structure of the buffer layer comprises at least one unit cell having at least one cell wall. Preferably, at least one cellular structure is a multicellular structure chosen from the group of a 2.5D structure, a foamed structure, and/or a 3D or lattice structure. In one embodiment of the invention, it is conceivable that at least one cellular structure is a 2.5D structure chosen from the groups of two-dimensional cellular structures shaped and/or extruded in a third dimension and/or a two-dimensional planar material shaped, extruded and/or thermoformed in a way that introduces a third dimension. Said 2.5D structure conceivably comprises a plurality of unit cells that exhibit similar shape and sizes, however in some cases, the unit cells exhibit non-repeating shapes and/or sizes that may be tuned to predefined sound frequencies to improve attenuation, absorption, or insulation. In another example, the multi-cellular structure, more preferably the 2.5D structure, comprises any polygon or “n”-gon matrices, wherein the n is a whole number representing the polygon's number of sides. It is conceivable that the 2.5D structure forms at least partially a honeycomb or hexagon structure. Preferably, the honeycomb or hexagon structure is buckling oriented. The use of such configuration could positively contribute to the force distribution upon impact. It is conceived that the honeycomb structure, hexagon structure and/or polygon or n-gon matrices imparts energy dissipation with lower thickness but with higher specific strength. In a yet another embodiment of the present invention, the multi-cellular structure and/or 2.5D structure may also include honeycomb tubes, honeycomb impressions, cylindrical punched impressions, zigzag patterns, wavy patterns, corriboard, corflutes, fluted plastic, corrugated plastic, corrugated polypropylene, conduits, grooves, surface cavities of varying dimensions, or cylinders, among others. It is likewise a possibility that the dimensions of honeycomb structure or the polygon or n-matrices influence the dissipation and/or direction of the reflection of mechanical kinetic energy, wherein there is an occurrence of destructive interference of the mechanical kinetic energy, rendering the dissipation of kinetic energy through the panel. It is further conceivable that the honeycomb structure or the polygon or n-matrices may at least be partially made of aluminium or other lightweight materials that provide excellent strength-to-weight ratio. Preferably, the combination of aluminium and the honeycomb structure, in particular hexagonal honeycomb structure, provides exceptional load-bearing capabilities allowing the buffer layer, and the panel in whole, to withstand significant impact forces and dissipate them more evenly and effectively across the buffer layer, and the panel in whole.

It is conceivable that the 2.5D structure has a strength-to-weight ratio in the range of 50 MPa*cm3/g to 400 MPa*cm3/g, in particular from 55 MPa*cm3/g to 300 MPa*cm3/g, more in particular from 60 MPa*cm3/g to 250 MPa*cm3/g. It has been experimentally found that at these ranges of the strength-to-weight ratio, the at least one buffer layer provides optimum structural stability and rigidity without subduing the capacity of the panel to cushion the body and to be compliant such that the panel is able to absorb a significant amount of impact when a fall happens. In case a foam structure is applied, it is conceivable that the foamed structure comprises unit cells having shapes that are randomly generated and have cell walls that are in random orientation. The foamed structure could comprise at least one material chosen from the group of: a closed cell foam, an open cell foam, a compressible natural material and/or a compressible elastomer. The cell foam material could also be a closed cell flexible foam. Alternatively, the buffer layer could comprise at least one spring-like material, rebound layer, compressible layer, or any means for cushioning or a cushion-like material. It is also possible that at least one cellular-structured layer comprises at least one material chosen from the group of: polyolefin foam, expanded polystyrene, expanded polypropylene, (expanded) rubber, ethylene-vinyl acetate (EVA), irradiation-crosslinked polyethylene (IXPE) and/or expanded polyethylene. This could possibly also be polypropylene (XPP) and/or expanded polystyrene (XPS). In a preferred embodiment, at least one cellular-structured layer comprises at least 50% of a foam material, for example but not limited to a closed cell foam material. Possibly, the cellular-structured layer comprises at least 80% of a foam material, in particular a closed cell foam material. A closed cell foam material is beneficial for the intended purpose as this material enables sufficient compressible behaviour whilst being sufficiently strong to support the decorative top layer and a load when applied. At least part of at least one cellular-structured layer could for example be made of a closed cell flexible foam. At least one cellular-structured layer could also comprise a semi-closed or open cell compressible foam. An open cell construction has the benefit of improved acoustical absorption. It is also possible that the cellular-structured layer is a substantially solid layer. Hence, it is thus possible that the compressible layer is not foamed. In this case best results are obtained with materials chosen from the groups of flexible polymers and elastomers such as but not limited to: rubber, latex, acrylic elastic epoxy, cis-polyisoprene (natural rubber, NR), cis-polybutadiene (butadiene rubber, BR), nitrile butadiene rubber (NBR), styrene-butadiene rubber (SBR), rubber, latex and/or ethylene-propylene monomer (EPM). An embodiment is also conceivable wherein at least one cellular-structured layer comprises gel, rubber and/or silicon. A combination of any of the mentioned materials, foamed or non-foamed, is possible too. At least one cellular-structured layer could for example also comprise at least one compressible natural material such as but not limited to: felt, cotton, wool, mycelium, hemp, cork, and/or the like. These examples are non-limiting and any similar foam materials having equivalent material properties could be applied. Yet in a further possible embodiment, at least one cellular-structured layer comprises a gel layer.

In yet another embodiment, it is conceivable that the lattice structure, if applied, comprises an array of spatial periodic unit cells with interconnected edges and faces and/or interconnected struts and nodes. It has been found that this formation of the lattice structure imparts sufficient stiffness and strength to the buffer layer while also ensuring that the buffer layer exhibits high energy absorption. Preferably, the lattice structure of the present invention has a bending-nominated mechanical response where the lattice structure experience bending moments within the buffer layer thereby making the buffer layer compliant. It is conceivable that the lattice structure has a Maxwell number M that is conceived to be lower than zero, or in other words, there are too few struts that balances the impact forces without balancing moments induced at the nodes of the structure thereby causing bending stresses to develop in struts and leading to bending-dominated mechanical response. For an architecture comprising s struts or walls and n nodes, joints or folds, the Maxwell's Number MN=s−3n+6, with a M>0 exhibiting rigid and non-compliant behavior, and an MN≤0 compliant and bending-dominated. In a preferred embodiment then, according to experimental data, at least part of the cellular structure, lattice structure, 2.5-dimensional and/or 3-dimensional architected material then features an MN≤0, preferably ≤−2, most preferably ≤−4, or is compliant and bending-dominated.

It is conceivable that the cellular structure of at least one buffer layer comprises a 2.5D, 2.5-dimensional structure and/or planar architected material. By having a 2.5-dimension continuous lattice configuration, the lattice structure is formed by a plurality of folding points and a plurality of cell walls or struts that are repeated at least once in at least one axis. It has been experimentally found that due to the structural uniformity of a 2.5D lattice structure, a controlled collapse response is achieved in which the buffer layer exhibits optimum and gradual impact/energy absorption, while allowing to finetune the exact Fmax, yield point or displacement threshold the structure exhibits. It is conceivable that the cellular structure having a 3D or lattice structure and/or a 2.5D structure comprising a plurality of faces or struts and folding points or nodes, wherein the faces or struts are at an oblique angle to the axial impact force, exhibits a gradual reduction in impact force, or a gradual dissipation of impact force, whereas faces or struts that run parallel to the axial impact force, do not exhibit a gradual reduction. The angle at which the faces or struts are oriented relative to the axial impact force can therefore significantly affect the gradual dissipation of impact force in a cellular structure. When the faces or struts are at oblique angles to the axial impact force, they tend to promote gradual dissipation of impact force by distributing the force over a larger area and allowing for controlled deformation. In this configuration, forces are directed along the diagonal of the lattice faces, which can help absorb energy and reduce peak forces. It is found by experimentation that angles in the range of 30 degrees to 60 degrees relative to the axial impact force are steep enough to provide structural stability and therefore a suitably high Fmax, threshold and/or displacement threshold but also sufficiently oblique to promote gradual dissipation according to the invention.

It is conceivable that the cellular or lattice structure comprises a 3-dimensional architected material. By being a 3-dimensional architected material, the lattice structure is formed by a plurality of nodes and a plurality of cell walls or struts repeated at least once in at least 2 axes. In some configurations, the plurality of struts or cell walls comprise at least one folding point. Moreover, the struts and/or cell walls are oblique, in particular 30-60 degrees in orientation, with respect to the expected direction of the impact force to avoid the weak points of the struts and/or cell walls. By following this configuration, the impact force is dissipated in the structure in a preferred manner that enhances the safety features of the panel.

It is conceivable that such a 3-dimensional architected material is a metamaterial, an artificial periodic structure, such as perforated honeycomb-corrugation hybrid carrier, micro-perforated panel, helical-structured acoustic metamaterial, and/or open, noise-cancelling structure for acoustic-silencing metamaterials which can impart excellent mechanical strength and impact energy absorption ability to the building panel. Preferably, the at least one metamaterial used in the buffer layer or, in some cases, in any part of the panel is a composite material or composite media that are made up of micro or nanoparticle building blocks having repetitive patterns to interact with soundwaves or external forces such as compression or impact to produce beneficial effects such as sound attenuation, shock absorption, impact reduction, or combinations thereof.

At least one metamaterial may comprise a material chosen from the group consisting of liquid crystal elastomers (LCE), foam-based LCE, high-energy absorbing LCE, shell lattice (SL) metamaterials, bending-dominated metamaterials, stretching-dominated metamaterials, octet lattice materials, truss lattice materials, shellular materials, sonoblind, or combinations thereof. In a possible embodiment, the at least one metamaterial relies on the geometry of their subunits to effectively function as a shock absorption or cushioning material. In this case, the metamaterials that can be used are classified into auxetic metamaterials such as re-entrant structure, 3D buckyball, fiber network mats, crystalline rolled-up tubes; pentamode metamaterials such as pentamode structure and Kagome structure; pattern transformation such as Holey sheets and Biholar sheets; cellular origami such as stacked miuri-ori and interleaved miuri-ori; origami metamaterials such as miura-ori tessellated pattern, non-periodic Ron Resch pattern, square twist, and kirigami; chiral systems such as trichirals, tetrachirals, and hexachirals; micro-/nanolattices such as stretch-dominated octet-truss and bend-dominated tetrakaidecahedron; and/or combinations thereof. By using at least one metamaterial and/or architected material in at least one buffer layer, the mechanical properties leading to shock absorption and/or cushioning effect can be modified for optimal performance. Such properties include the metamaterial or the buffer layer's stiffness, rigidity, and compressibility that are dependent on the Poisson's ratios, shear/bulk modulus, Young's modulus, or combinations thereof. In a preferred embodiment, at least one metamaterial and/or architected material that forms at least a part of at least one buffer layer is produced via subtractive manufacturing and/or additive manufacturing (AM) such as selective laser melting (SLM), or combinations thereof. These manufacturing methods allow the fabrication of strong and lightweight structures with geometry that is complex for traditional manufacturing methods.

It is also conceived that the interconnected edges and faces are similar to crystal structures such as the face-centered cubic (FCC), body-centered cubic (BCC), and the hexagonal close-packed (HCP) structure. The shape and size of the unit cells in the lattice structure can be uniform or non-uniform. The said structures define the multicellular layer construction such as the number of contact points between adjacent cellular structures. For example, by following the BCC structure, the buffer layer comprises adjacent cellular structures that are coupled in at least 8 corner positions with each other. When the FCC structure is used, the individual cellular structures that made up the buffer layer are connected in at least 14 connection points derived from the sum of the 8 corner points and the 6 center points of the cubic structure. The HCP structure can also be used in the multicellular structure of the buffer layer wherein there are 12 corner points and 2 center points for the top and bottom face of the hexagonal structure. In another preferred embodiment, the multicellular-structured layer is chosen from the group consisting of a cubic structure, hexagonal lattice structure, origami structure, folded structure, or combinations thereof.

The flexibility of a floor layer, for example the top layer, the buffer layer and/or the core layer is typically measured according to EN 310 or ASTM D790. The flexibility measured according to said standards measures the ability of a material to withstand deformation when a perpendicular force is applied to its surface. The hardness of the panel layer can further be measured with a durometer. In this method a higher number corresponds to a higher hardness. The hardness is an indication of the ability of the tested material to deform locally at a point of pressure when a perpendicular force is applied to its surface. Shore A is generally used for softer materials using a needle with a blunted point; while Shore D is used for medium hard to hard surface measurements using a needle that ends with a 30°, sharp point angle. In general, a Shore A classification can be made from very soft (0-40), soft (40-75), and medium hard (75-95); a Shore D classification can be made from soft (8-25), medium hard (25-46) and hard (46-90). There is a certain overlap between the two scales, with a (soft) Shore A of 40-75 being similar in hardness to a Shore D of 8-25; and a (medium hard) Shore A of 75-95 being similar in hardness to a Shore D of 25-46.

At least one top layer, and in particular an upper surface of the at least one top layer, has a Shore D hardness of at least 60. However, it is also conceivable that in an alternative embodiment, the decorative top layer, and in particular the upper surface of the at least one decorative top layer, has a Shore D hardness in the range of 70 to 100, more in particular in the range of 75 to 85. These hardness ranges were found to be sufficiently rigid to achieve the desired technical effect of the present invention. At least one top layer more preferably has a Shore D hardness in the range of 60-90 and more preferably in the range of 60-75. Such panel benefits from an equilibrium between rigidity and flexibility, as imparted by at least one top layer that has a Shore D hardness of at least 60, preferably in the range of 70-85, and/or is semi-rigid, understood in light of the invention as having a modulus of elasticity of 1800 MPa to 5500 MPa, when tested according to EN 310, and/or being flexible around a mandrel having a diameter in the range of 50-350 mm when tested according to ASTM F137 or has a flexibility of 50 mm-350 mm in a Mandrel test according to ASTM F137. In case the panel is applied as floor panel, the panel according to the invention benefits of the presence of at least one buffer layer which allows the dissipation of kinetic energy that is exerted on the floor during impact, thereby reducing the impact forces. It was surprisingly found that the use of a panel having a semi-rigid top layer in combination with a buffer layer sandwiched between said top layer and at least one core layer, results unexpectedly in an improved reduction of the fall impact when compared with market alternatives, such as a panel having only a core layer in combination with a flexible decorative top layer, or a panel having a core layer in combination with a flexible decorative top layer and a compressible middle layer. Due to the Shore D hardness and modulus of elasticity of the top layer, it is also possible to apply a relatively thin decorative top layer whilst obtaining the desired effect.

In a preferred embodiment, the at least one top layer has a modulus of elasticity of at least 1,800 MPa up to 5,500 MPa. In another embodiment, the at least one top layer has a modulus of elasticity of at least 1,800 MPa up to 9,000 MPa according to EN 310. In a further possible embodiment, the at least one top layer has a modulus of elasticity between 5,000 MPa and 6,000 MPa. Other possible values are a modulus of elasticity of at least 2,500 MPa or at least 4,000 MPa. Additionally or alternatively, at least one top layer has a flexibility of 50 mm-350 mm in a Mandrel test according to ASTM F137. This means that the top layer is flexible around a mandrel having a diameter in the range of 50-350 mm when tested according to ASTM F137. In a preferred embodiment, the at least one top layer is flexible around a mandrel having a diameter in the range of 50-125 mm or 50 to 76 mm. The top layer is preferably not flexible, meaning it has a test result of at least 50 mm when tested to ASTM F137. The (decorative) top layer is preferably semi-rigid. It has been experimentally found that the combination of such ranges of flexibility/rigidity, in particular in combination with such ranges of modulus of elasticity according to the present invention, is a causal factor to a substantial improvement of the performance of the at least one decorative top layer upon impact of an individual or object falling on the floor. More particularly, such combination of the modulus of elasticity and hardness enables the energy imparted by the impact of an individual or object falling on the floor to be at least partially dissipated or absorbed in the system composed of the decorative top layer and the buffer layer. This means that the energy is first spread out over an area of the decorative top layer and is then transferred over a larger area of the buffer layer. The partial dissipation or absorption of the energy from said impact in the decorative top layer reduces the reactive forces applied by the floor panel to the impacting individual or object and thereby also decreases the energy returned by the floor during impact. As a result, gradual energy restitution in the panel is improved and consequently reducing or minimizing the risk of injury to individuals who fall on the panel of the present invention. In addition, ease of movement on the floor is also boosted thereby providing relatively more comfort specially to individuals who have physical difficulties and can support stresses exerted on small surfaces such as is the case with wheelchairs or motorized chairs.

The panel according to the present invention can be referred to as a hard surface floor panel suitable for constructing a floor covering. The panel preferably has a G-max of less than 150, in particular less than 120 G and/or an HIC (Head Injury Criteria) of less than 800, in particular less than 600, more in particular less than 500 when tested to ASTM F1292-09. Experimental results which support this embodiment are shown hereinafter in Table 1.

TABLE 1
G-max and HIC Results

| | Height | G-max | | Critical |
|---|---|---|---|---|
| Construction | (ft) | (G's) | HIC | Height (ft) |
| semi-rigid top layer + one buffer | 8 | 117 | 546 | >10 |
| layer | 9 | 126 | 605 | |
| | 10 | 147 | 715 | |
| semi-rigid top layer + two distinct | 8 | 105 | 407 | >10 |
| buffer layers | 9 | 113 | 453 | |
| | 10 | 132 | 473 | |
| semi-rigid top layer + two identical | 8 | 120 | 551 | >10 |
| buffer layers | 9 | 128 | 607 | |
| | 10 | 150 | 728 | |

G-max is defined as the maximum acceleration of a missile during impact, expressed in G units. The HIC is defined as a specific integral of the acceleration-time history of an impact, adopted to determine relative risk of head injury. The fatal limit of G-max is defined to be 200 G and that of the HIC is 1,000. The floor panel according to the present invention provides sufficient scores on these tests due to the combination of the decorative top layer and the buffer layer. In addition to the good impact performance when compared to the conventional rigid floors or hard surface floor panels as manifested by an observed lower G-max and HIC, a floor covering using panels according to the present invention is still comfortable to walk and play on.

At least one top layer is preferably a decorative top layer. At least one top layer may comprise at least one polymer material and preferably at least one mineral filler. It is also imaginable that at least one top layer comprises a multitude of plies of resin impregnated paper or at least one cellulose-based material chosen from at least one wood veneer and/or at least one bamboo veneer. At least one decorative top layer could also comprise at least one décor layer. At least one decorative top layer may comprise a digitally printed décor layer. In an embodiment, at least one decorative top layer comprises at least one polymer material and preferably at least one mineral filler. At least one top layer preferably has a thickness in the range of 0.05 to 5 mm, preferably in the range of 1 to 4.5 mm, more preferably in the range of 1.5 to 4 mm. At least one top layer could also have a thickness in the range of 0.1 to 2 mm. It is also conceivable that at least one top layer has a thickness in the range of 1 to 4 mm or 1.5 to 3 mm. Typically, the thickness of the decorative top layer is smaller than 3.5 mm, preferably smaller than 3 mm. It is beneficial to apply a relatively thin but semi-rigid top layer. This will positively contribute to the force impact and the force distribution.

At least one (decorative) top layer preferably has an average density of at least 1000 kg/m3. The top layer can for example have a density of at least 1000 kg/m3, preferably at least 1200 kg/m3, 1300 kg/m3 or 1400 kg/m3. Such range of values for the density of the top layer ensures that the ability of the floor panel to cushion future impacts following simple or percussive impacts is not inhibited or that the floor is not too rigid to get damaged during impact from a fall, in the panel case applied as floor panel.

In a possible embodiment, at least one decorative top layer comprises at least one cellulose-based material. At least one decorative top layer could also comprise at least one layer made of paper where a decorative pattern is printed upon. It is conceivable that the paper, if applied, is flexible and/or roller compatible. At least one decorative top layer could comprise at least one wood veneer and/or at least one bamboo veneer. The decorative top layer could also comprise a multitude of plies of resin impregnated paper or wood veneers. The decorative top layer may be in the form of a multi-stacked layer, multi-oriented layers, closed layer, fibrous layer, fibrous mesh, interlaced fibers, weaved or webbed structure. It is also conceivable that the at least one decorative top layer comprises at least one substantially transparent wear layer or protective finish. The wear layer may comprise one or more transparent layers of a thermoplastic or thermosetting resin. Non-limiting examples of thermoplastic or thermosetting materials which could be used are polyvinyl chloride (PVC), polystyrene (PS), polyethylene (PE), polyurethane (PU), acrylonitrile butadiene styrene (ABS), polypropylene (PP), polyethylene terephthalate (PET), polybutylene terephthalate (PBT), polytrimethylene terephthalate (PTT), polyethylene naphthalate (PEN), phenolic and/or melamine or formaldehyde resins. Said wear layer may also be in a liquid or paste-like form made of a thermosetting resin such as, but not limited to, phenolic and/or melamine or formaldehyde resins. The wear layer may comprise or may be substantially composed of an inherently scratch-resistant thermosetting resin impregnating a carrier layer such as paper or lignocellulose. An advantage of this latter embodiment is that the urea-formaldehyde also acts as a relatively scratch-resistant wear layer. Typically, a preferred thickness of the wear layer structure in the panel of the invention is in the range of 0.1 to 2.0 mm, more preferably between 0.15 mm to 1 mm and most preferably between 0.2 mm to 0.8 mm. It is conceivable that the wear layer has a larger thickness than a décor layer. It is for example possible that at least one wear layer has a thickness of about 0.15 to 1 mm. The total thickness of the decorative top layer is in that embodiment typically between 0.17 to 1.07 mm. Said at least one wear layer may for example cover partly an upper surface of the decorative layer, more preferably at least 50% of said upper surface of the decorative layer is covered, and most preferably, said at least one wear layer covers the entirety of the upper surface of the decorative layer. It is conceivable that said at least one wear layer may further comprise abrasive materials to improve the wear resistance thereof. Non-limiting examples of said abrasive materials are aluminium oxide such as quartz, silica, corundum, carborundum, silicon carbide, glass, glass beads, glass spheres, diamond particles, hard plastics, reinforced polymers and organics, or a combination thereof. At least one wear layer can for example be based on any thermoplastic or thermosetting material. The wear layer may further comprise a filler, for example based on calcium, carbonate or magnesium. The decorative top layer could also be composed of a carrier material layer designed to be provided with a decorative pattern. The carrier material may be woven, extruded or calendared plastic net, sheet or film. Non-limiting examples of thermoplastic or thermosetting materials which could be used are polyvinyl chloride (PVC), polystyrene (PS), polyethylene (PE), polyurethane (PU), acrylonitrile butadiene styrene (ABS), polypropylene (PP), polybutylene terephthalate (PBT), polytrimethylene terephthalate (PTT), polyethylene naphthalate (PEN), phenolic and/or melamine or formaldehyde resins.

The panel preferably comprises at least one pair of opposite side edges which are provided with interconnecting and/or complementary coupling parts for interconnecting adjacent panels. Said interconnecting coupling part could either form part of at least one decorative top layer, at least one buffer layer and/or of at least one core layer. The coupling parts of the panel may for example be interlocking coupling parts, which are preferably configured for providing both horizontal and vertical locking. Interlocking coupling parts are coupling parts that require elastic deformation, a click or a movement in multiple directions to couple or decouple the parts with or from each other. Any suitable interlocking coupling parts as known in the art could be applied. A non-limiting example is an embodiment wherein a first edge of said first pair of opposing edges comprises a first coupling part, and wherein a second edge of said first pair of opposing edges comprises a complementary second coupling part, said coupling parts allowing a plurality of panels to be mutually coupled; wherein the first coupling part comprises a sideward tongue extending in a direction substantially parallel to a plane defined by the panel, and wherein the second coupling part comprises a groove configured for accommodating at least a part of the sideward tongue of another panel, said groove being defined by an upper lip and a lower lip.

Preferably, at least one top layer is positioned upon or above at least one buffer layer. It is conceivable that there is no attachment between the buffer layer and the decorative top layer. An embodiment is also possible wherein at least one decorative top layer is positioned upon or above at least one buffer layer with the interference of an adhesive layer. In yet a further possible embodiment, there are several contact points between the buffer layer and the decorative top layer. In such embodiment, it is also conceivable that part of the decorative top layer is positioned upon or above at least one buffer layer with the interference of an adhesive layer whilst determined connection points between said layers are present. The top layer can for example be configured to come into contact with the buffer layer upon depression thereof. It is also possible that at least one air gap is present between at least part of at least one decorative top layer and at least one buffer layer, in particular at least when no pressure is applied to the panel. Alternatively, it is also possible that an air gap is present between at least part of at least one buffer layer and at least one core layer in particular at least when no pressure is applied to the panel. It is for example imaginable that the top layer is attached to the core layer in particular via at least part of their perimeter. It is thereby conceivable that the buffer layer is attached to at least part of the core layer but not to the top layer, or vice versa. The buffer layer could also be made of a substantially sticky material, in particular such that the use of an adhesive can be omitted.

The panel according to the present invention preferably comprises at least one core layer. The presence of a core layer could further contribute to the impact and/or sound performance of the panel. At least one core layer generally comprises at least one binder and at least one filler. Said core layer may further comprise at least one additive. Preferably, in a non-limiting embodiment of the invention the panel may comprise any material, such as plastic including polyvinyl chloride (PVC), polyethylene (PE), polypropylene (PP), polyethylene terephthalate (PET), polyethylene terephthalate glycol (PETg), polyurethane (PU), polybutylene terephthalate (PBT), polytrimethylene terephthalate (PTT), polyethylene naphthalate (PEN), (wood) plastic composites, mineral substances, magnesium oxide, gypsum, glass, sand, wood, mycelium or mixtures (or combinations) thereof. Preferably, the core layer includes at least one filler selected from the group consisting of: minerals, preferably calcium carbonate, talc, dolomite, calcite; and pigments, modifiers, fibers, such as: glass fiber, wood, straw and/or hemp. The fibers can be loose fibers and/or interconnected fibers to form a woven or nonwoven layer. Preferably the core layer further includes at least one additional filler selected from the group consisting of steel, glass, polypropylene, wood, acrylic, alumina, curaua, carbon, cellulose, coconut, Kevlar, Nylon, perlon, polyethylene, PVA, rock wool, viburnum, bentonite, ATH, MDH, and fique. This can further increase the strength of the panel itself and/or the water resistance and/or fire resistance of the panel. The core layer may also comprise a combination or composite of any of the materials previously mentioned. It is conceivable that the composite material comprises at least 20% by weight of filler and/or 15% to 50% by weight of a binder. This range is found to secure sufficient stability and strength of the core layer while also allowing for necessary flexibility thereof and improving temperature resistance as well.

A non-limiting example of a core layer which could be applied is a composite core layer comprising at least one mineral material and at least one binder. The core layer could for example comprise at least 60 wt % mineral material, preferably at least 70 wt % mineral material. A higher mineral content typically results in a more rigid core layer and thus a more rigid panel. Moreover, due to the relatively large quantity of mineral material a relatively good temperature resistance can be obtained, in particular with respect to conventional floor panel having a core layer which is predominantly thermoplastic. It is conceivable that at least one core layer comprises at least one mineral material selected from the group consisting of: magnesium oxide, calcium carbonate, chalk, clay, calcium silicate and/or talc. As a further non-limiting example, limestone (e.g. calcium carbonate with magnesium carbonate) may be used as mineral material in the core layer. Possibly, the mineral material is present as particulate mineral filler.

In one embodiment at least one core layer has a rigidity below 3,500 MPa, preferably below 2,000 MPa and/or has a rigidity below 75 mm, more preferably below 50 mm or in the range of 25 to 50 mm when tested via a Mandrel test according to ASTM F137. A panel with such a core may be particularly suitable for a gluedown installation. It is also possible to apply a core layer having a rigidity of 1,800-9,000 MPa, preferably 2,500-5,500 Mpa in particular when measured according to EN310 or ASTM D790 and/or has a rigidity in the range of 50 to 350 mm when tested via a Mandrel test according to ASTM F137. Such core layer benefits from a sufficiently high rigidity to provide sufficient support for the decorative top layer and the cellular-structured layer and could allow for the provision of an interlocking mechanism. The core layer could further act as impedance layer such that it further impedes the transmission of sound or further aids in providing an impact reduction means for the panel. It is possible that the core layer further comprises at least one natural material, such as wood fibers, mycelium, wool, straw, hemp and the like. The core layer preferably has a density of at least 1200 kg/m3, preferably at least 1400 kg/m3. The density of the core layer could for example be in the range of 1600 to 2100 kg/m3.

In a preferred embodiment, at least part of an upper and/or lower surface of the core layer comprises a plurality of cavities. The presence of cavities in the upper and/or lower surface of the core layer could further contribute to performance of the panel. The plurality of cavities could for example define a predetermined pattern, which may be a repeated cavity pattern. The upper and/or lower surface of the core layer preferably at least partially comprises a predetermined pattern of shock absorbing cavities. Possibly, at least part of the cavities may differ in depth, shapes, sized and/or angles. It is conceivable that the cavities feature different depths, shapes, sized and/or angles designed to scatter different frequencies of sound waves. At least part of the cavities may be impressed cavities. At least part of cavities may for example be obtained via additive or subtractive manufacturing, pressing means, imprinting, rotary imprinting and/or rotary (die) cutting. It is beneficial if the cavities are present in a central region of the panel. At least one outer edge and preferably all outer edges of the core layer may be free of cavities. Hence, it is conceivable that the cavity or cavities do not extend through the outer edge(s) of the panel. It is for example conceivable that at least 1 cm from each outer edge of the panel is free of cavities. It is for example also possible that the circumferential edge of the panel, and in particular the core layer, is over of at least 2 centimetres free of cavities. In case a core layer is applied which comprises a plurality of cavities, in the upper surface and/or in the lower surface of the core layer, the density is only determined by the actual material of the core layer wherein the cavities are not taken into account. The core layer typically has a thickness ranging from 2 to 20 mm, preferably in the range of 2 to 8 mm, more preferably in the range of 3 to 5 mm. A further non-limiting example is a core layer in the range of 3.5 and 4.5 mm.

In a possible embodiment, the panel according to the invention comprises at least two buffer layers situated between at least one core layer and at least one decorative top layer. In such embodiment, it is conceivable that at least one upper buffer layer and at least one lower buffer layer are separated via at least one intermediate layer. Such intermediate layer could for example be a reinforcing layer.

Said at least one reinforcing layer may comprise of an organic or inorganic material or a combination of both such as, but not limited to, polymers, glass, ceramics, minerals, and metals. Any of the further examples mentioned in this application could be applied to. The function of at least one reinforcing layer could also be that of a distance element between the buffer layer and the decorative top layer.

In a possible embodiment, the reinforcing layer may be in the form of a multi-stacked layer, multi-oriented multi-stacked layers, closed layer, porous layer, fibrous layer, fibrous mesh, interlaced fibers, gel, pellets, microbeads, beads, foam layer, mesh, crisscross mesh, honeycomb mesh, sheet, film, tubes, liquid-filled tubes, vacuum tubes, hollow tubes, aerogel-filled tubes, weaved or webbed structure. Yet in another possible embodiment, a stack of decorative top layers and cellular-structured layers according to the invention can be applied. It is for example conceivable that the panel comprises a stack of at least two or three (decorative) top layer and at least two or three cellular-structured layers.

In a preferred embodiment the panel comprises at least one backing layer attached to a rear side of the core layer. The backing layer might be also called an additional cushioning layer or damping layer. The backing layer is typically made of a polymer material, for example but not limited to a low-density foamed layer, of ethylene-vinyl acetate (EVA), irradiation-crosslinked polyethylene (IXPE), expanded polypropylene (XPP) and/or expanded polystyrene (XPS). However, it is also conceivable that the backing layer comprises nonwoven fibers such as natural fibers like hemp or cork, and/or recycled/recyclable material such as PET, felt, recycled carpet and the like.

The cushioning or backing layer could contribute to the impact performance of the panel. A backing layer is further helpful in providing an optimum interface between the panel and the underlying surface on which the panels are applied and may provide a protective function for the core layer. It also allows to absorb some subfloor irregularities. The backing layer, if applied, preferably has a density in the range of 65 kg/m3 and 300 kg/m3, more preferably in the range of 80 kg/m3 and 150 kg/m3. The thickness of the backing layer typically varies from about 0.1 to 2.5 mm. Non-limiting examples of materials whereof the backing layer can be made of are polyethylene, cork, polyurethane and ethylene-vinyl acetate. In one embodiment, it is also conceivable that the panel comprises (at its back surface) at least one balancing layer, generally composed of at least one layer comprising lignocellulose and a cured resin, a wood or bamboo veneer, and the like. It is conceivable that the cushioning or back layer comprises at least one buffer layer according to the present invention.

The invention also relates to a top layer for use in a panel according to the present invention. The invention further relates to a buffer layer for use in a panel according to the present invention. The decorative top layer and/or the buffer layer can be any of the described embodiments. The invention also relates to an assembly of at least one top layer and at least one buffer layer for use in a panel according to the present invention.

The invention further relates to a floor covering comprising multiple panels, in particular floor panels, according to the present invention.

The invention also related to a method for manufacturing a floor, wall, ceiling or building panel, comprising:
providing at least one core layer;
providing at least one top layer, in particular at least one decorative top layer; and
providing at least one buffer layer,
laminating the at least one core layer, the at least one buffer layer and the at least one
top layer together such that the at least one buffer layer is situated between the at least
one core layer and the at least one top layer,
wherein the at least one buffer layer comprises at least one cellular structure, in particular at least one multicellular structure, and
wherein at least one top layer has a Shore D hardness in the range of 60-90 and a flexibility of 50 mm-350 mm in a Mandrel test according to ASTM F137.

### BRIEF DESCRIPTION OF THE FIGURES

The invention will be further elucidated by means of non-limiting exemplary embodiments illustrated in the following figures, in which:

FIG. 1a shows a perspective view of a first embodiment of a panel according to the present invention;

FIG. 1b shows a cross section of the panel as shown in FIG. 1a;

FIG. 2 shows a cross section of a second embodiment of a panel according to the present invention;

FIG. 3 shows a cross section of a third possible embodiment of a panel according to the present invention;

FIG. 4 shows a cross section of a fourth possible embodiment of a panel according to the present invention;

FIGS. 5a-50 show the non-limiting alternative materials for the buffer layer for use in a panel according to the present invention;

FIGS. 6a and 6b show the force-displacement curves of a conventional panel vs the panel according to the present invention; and

FIG. 7 shows a cross section of a fifth possible embodiment of a panel according to the present invention.

Within these figures, similar reference numbers correspond to similar or equivalent elements or features.

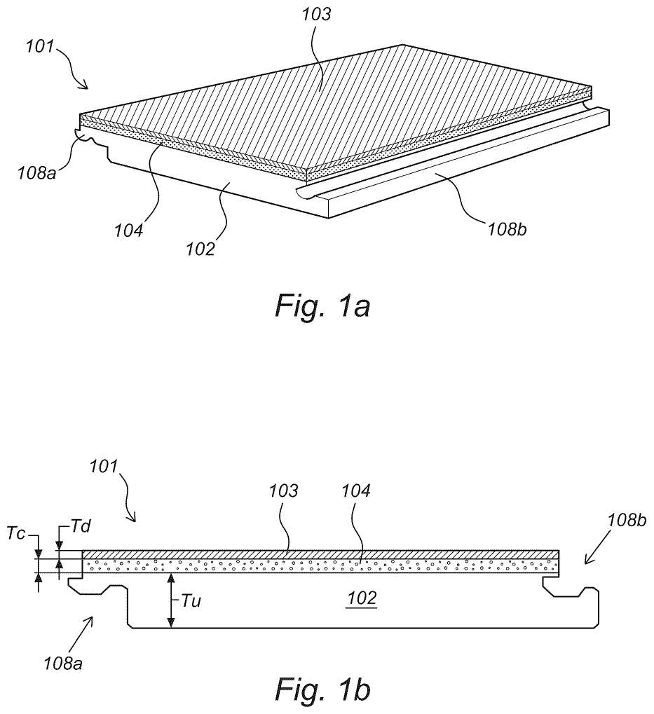

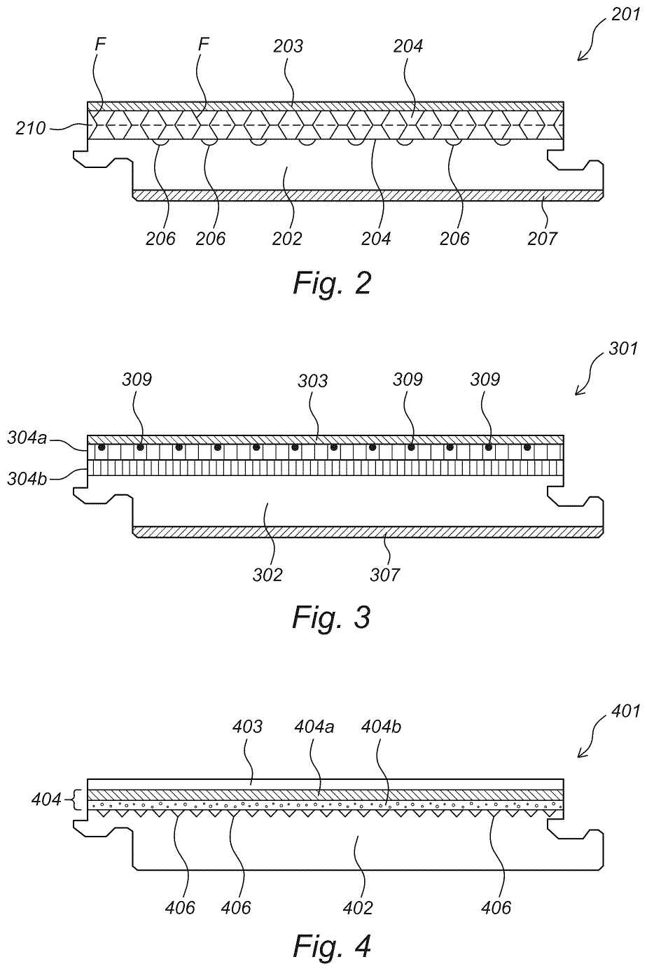

FIG. 1a shows a perspective view of a first embodiment of a panel, in particular a floor panel 101 according to the present invention. FIG. 1b shows a cross section of the panel 101 as shown in FIG. 1a. The panel 101 comprises a core layer 102, a decorative top layer 103 and a buffer layer 104. The buffer layer 104 is situated between the core layer 102 and the decorative top layer 103. The decorative top layer 103 benefits of a rigid character. In the shown embodiment, the thickness Td of the decorative top layer 103 is smaller than the thickness Tc of the buffer layer 104. The thickness Tu of the core layer is substantially larger than the thicknesses Td, Tc of the decorative top layer 103 and the buffer layer 104. The core layer 102 comprises two pairs of opposite side edges. In the shown embodiment, a first pair of opposite side edges is provided with interconnecting coupling parts 108a, 108b for interconnecting adjacent panels 101.

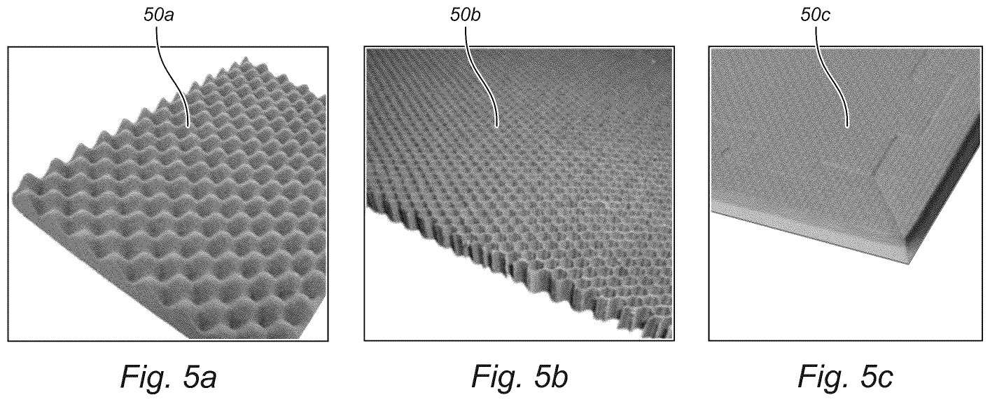

FIG. 2 shows a cross section of a second possible embodiment of a panel, in particular a floor panel 201 according to the present invention. The panel 201 comprises a core layer 202, a top layer 203 and a buffer layer 204. The top layer 203 is in particular a decorative top layer. The buffer layer 204 has a cellular structure comprising struts and/or cell walls which comprise multiple folding points F. The folding points F are positioned at the same height within the buffer layer 204 indicated by dotted line 210. In the shown embodiment, an upper surface of the core layer 202 comprises a plurality of cavities 206 which are present in a predetermined pattern configured to scatter impact forces and incoming sound waves. The panel 201 could optionally comprise a backing layer 207.

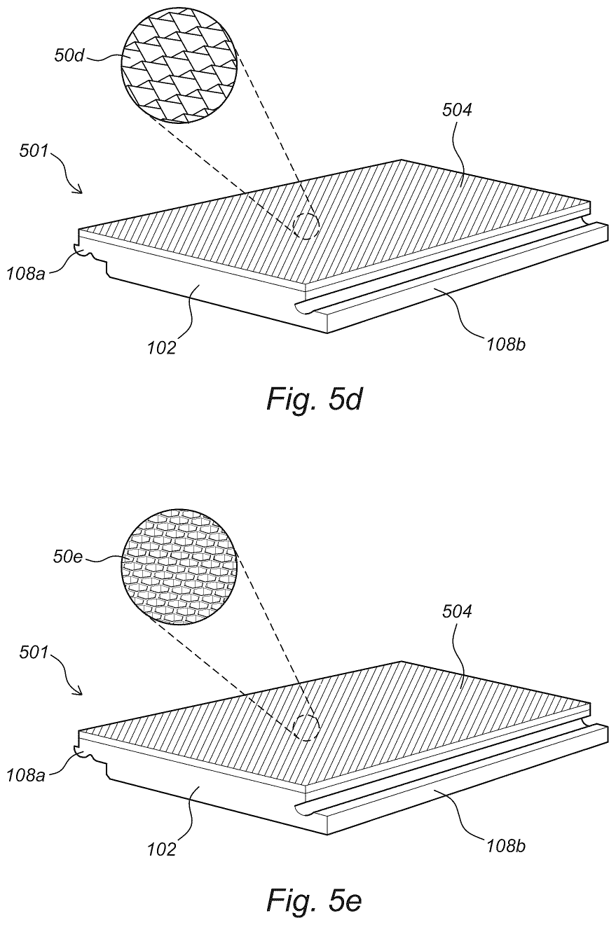

FIG. 3 shows a cross section of a third possible embodiment of a panel, in particular a floor panel 301 according to the present invention. The panel 301 comprises a core layer 302, a decorative top layer 303 and two buffer layer 304a, 304b, whereof each buffer layer 304a, 304b comprises a cellular structure. In the shown embodiment, the compressibility of the first buffer layer 304a is larger than the compressibility of the second buffer layer 304b. The panel 301 further comprises backing layer 307. The decorative top layer 303 is attached to the buffer layer 304 by means of a plurality of connection points 309.

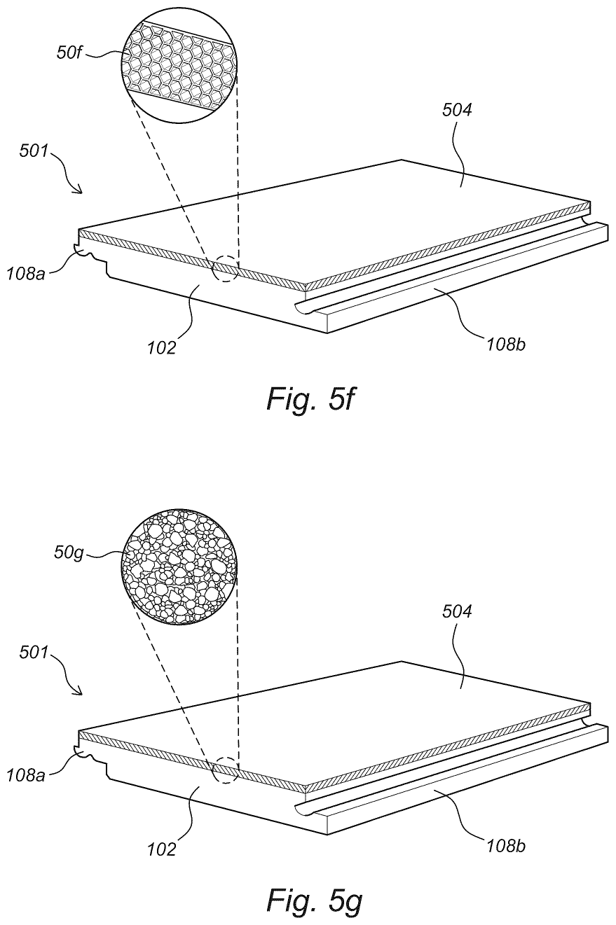

FIG. 4 shows a cross section of a fourth possible embodiment of a panel, in particular a floor panel 401 according to the present invention. The panel 401 comprises a core layer 402, a decorative top layer 403 and a buffer layer 404. The upper surface of the core layer 402 comprises a plurality of cavities 406 which are present in a predetermined pattern. The buffer layer 404 comprises an upper buffer layer 404a and a lower buffer layer 404b. In an embodiment, the upper buffer layer 404a comprises a different material than the lower buffer layer 404b or in some cases, both the upper buffer layer 404a and the lower buffer layer 404b comprises the same material to achieve the desirable effects of this invention.

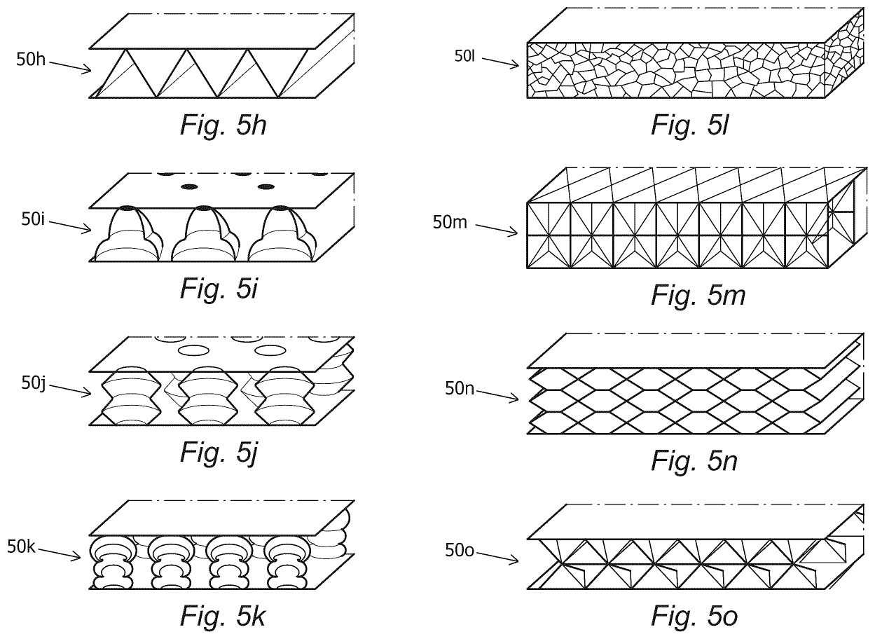

FIGS. 5a, 5b and 5c shows the non-limiting alternative materials for use in a buffer layer of a panel, in particular a floor panel according to the present invention. FIG. 5a shows an embodiment wherein the buffer layer material comprises a three-dimensional structure foam layer 50a. FIG. 5b shows the buffer layer material 50b comprising a honeycomb structure which can effectively absorb impact acting like a cushioning layer. The honeycomb structure in particular comprises unit cells of hollow vertical structures such as cylindrical honeycomb unit cells. The structure of FIG. 5b is substantially more rigid than for example the foam layer 50a of FIG. 5a. FIG. 5c shows a buffer layer material 50c comprising an ethylene-vinyl acetate (EVA) layer 50c. This is for example a closed cell foam such as an expanded rubber or foam rubber, or any other padding means used for cushioning especially in sports flooring. FIGS. 5d-5f show panels 501 according to the present invention which comprise a buffer layer 504, wherein each buffer layer 504 comprises a different buffer material 50. FIG. 5d shows an embodiment wherein the buffer layer material 50d comprises a Voronoi-tesselated structure 50d. The Voronoi-tesselated structure 50d comprises of irregular cell boundaries and void spaces that are configured to optimize energy dissipation or impact resistance during an impact or deformation. A detailed view thereof is shown. FIG. 5e shows an embodiment wherein the buffer layer material 50e comprises a buckling-oriented honeycomb structure. The buckling-oriented honeycomb structure exhibits significant vertical energy dissipation as the structure deforms and collapses during buckling or when the structure deforms axially due to compressive out of plane impact forces, while maintaining great strength laterally. FIG. 5f shows another embodiment of a buffer material 50f with a buckling-oriented honeycomb structure. FIG. 5g shows yet another embodiment of a panel 501 comprising a buffer layer according to the present invention. FIGS. 5h-50 show a series of further non-limitative buffer materials 50h-500 which could be applied in buffer layers according to the present invention. FIGS. 5h-5k show 2.5-dimensional architected materials and FIGS. 5l-5o show 3-dimensional architected materials.

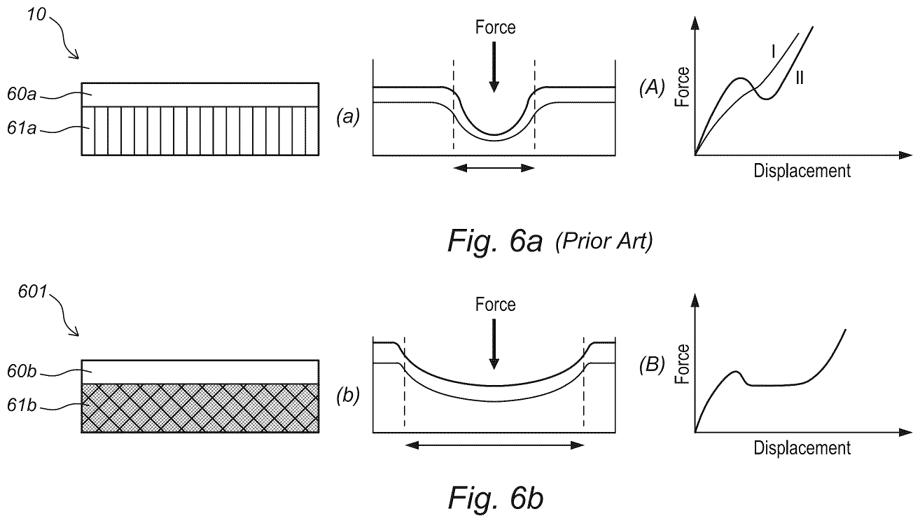

FIG. 6a is indicative of the state of the art, a shows a conventional panel 10 comprising a layer of vertically oriented deformable structures 61a, such as vertically aligned cell walls, that is disposed underneath a flexible top layer 60a. FIG. 6a further shows a representation of the performance of a conventional panel when force is applied thereto upon impact. As can be seen from the figure, the kinetic energy from impact of a falling individual is absorbed only at the point of impact and is dissipated over a small surface area for a relatively short period of time. Moreover, said vertical structures exhibit inertial effects due to the alignment of the material with the impact forces. It can be concluded that such conventional panel is not particularly suited to absorbing impact forces. FIG. 6b shows an embodiment of the panel 601 according to the present invention comprising at least one buffer layer 61b comprising a buckling-oriented deformable structure, such as the structures shown in FIG. 5a-50, disposed underneath a semi-rigid top layer 60b. As shown in the figure, the panel of the present invention exhibits bulk compression where the top layer and buffer layer deform or compress during impact in a manner that allows for the optimal distribution of energy within the top layer and buffer layer. During this bulk compression, the top layer gradually dissipates the kinetic energy from impact over a broad area first before transferring it to the buffer layer where the energy is converted to internal energy within the structure of the buffer layer. The internal energy is then released or absorbed gradually thereby significantly reducing the peak forces experienced during impact. As the energy is dissipated over a significantly larger area at a longer period of time, the energy transmitted back to the falling individual or object is effectively reduced thereby minimizing risk of damage or injury.

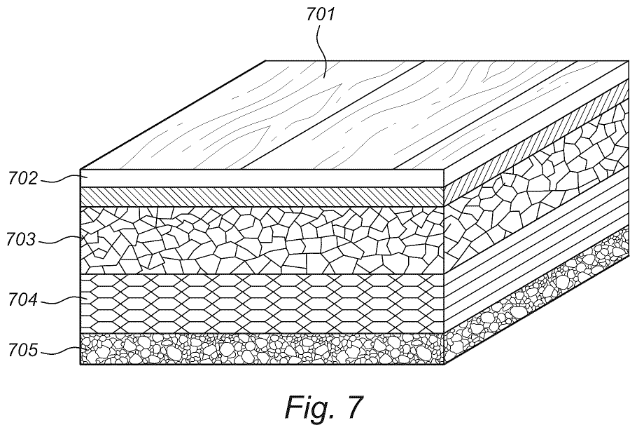

FIG. 7 shows a cross section of a possible embodiment of a panel 701, in particular a floor panel 701 according to the present invention. The panel 701 comprises a decorative top layer 702, a density decreasing Voronoi-tessellated 3D buffer layer 703, a buckling-oriented hexagonal 2.5D buffer layer 704 and a cushioning backing layer 705. The density gradient in the Voronoi-tesselated 3D buffer layer optimally disperses out-of-plane or axial impact forces exerted to the top surface. Moreover, due to the anisotropic nature of the buckling-oriented hexagonal 2.5D buffer layer, it is particularly suited to serve as a core layer in a floor panel and may even feature an interlocking mechanism on at least one of its side edges.

### CLAUSES

The invention will be further elucidated based on the following non-limitative clauses.
1. A floor, wall, ceiling or building panel, comprising:
   at least one core layer;
   at least one top layer, in particular at least one decorative top layer; and
   at least one buffer layer situated between at least one core layer and at least one top layer,
wherein at least one buffer layer comprising at least one cellular structure, in particular at least one multicellular structure, and
wherein at least one top layer has a modulus of elasticity of at least 1,800 MPa according to EN 310 and/or wherein at least one top layer has a flexibility of 50 mm-350 mm in a Mandrel test according to ASTM F137.
2. The panel according to clause 1, wherein at least one buffer layer comprises at least one multicellular structure chosen from the group of a hexagonal structure, honeycomb structure, a twinwall structure, a corflute construction, a foamed structure, a lattice structure or combinations thereof.
3. The panel according to any of the previous clauses, wherein at least one buffer layer comprises at least one multicellular structure comprising a 2.5-dimensional architected material, preferably a 2.5-dimensional continuous lattice configuration formed by n folding points and p cell walls repeated at least once in at least one axis.
4. The panel according to any of the previous clauses, wherein at least one buffer layer comprises at least one multicellular structure comprising a 3-dimensional architected material, preferably a 3-dimensional lattice configuration formed by n nodes and p struts repeated at least once in at least 2 axes.
5. The buffer layer according to clause 3 or clause 4, wherein the 2.5-dimensional architected material and/or 3-dimensional architected material is buckling-oriented, bending-dominated and/or has a Maxwell's Number of ≤0, preferably ≤−2, most preferably ≤−4.
6. The buffer layer according to any of clauses 3-4, wherein 2.5-dimensional architected material and/or 3-dimensional architected material features a threshold-activated constant-force response to axial forces, comprising an elastic deformation in a first time period, a yield point Fyield, a plastic deformation in a second time period, a densification deformation in a third time period, and an Fmax, wherein Fyield<Fmax.
7. The panel according to any of clauses 3-6, wherein the 2.5-dimensional and/or 3-dimensional architected material is chosen from the group of a hexagonal lattice structure, origami structure, folded structure and/or pentamode metamaterials.
8. The panel according to any of clauses 4-7, wherein at least part of the struts and/or cell walls comprise at least one folding point.
9. The panel according to any of the previous clauses, wherein at least one buffer layer comprises at least one cellular structure comprising a gradient structure, in particular a gradient discrete structure, a gradient increasing structure and/or gradient decreasing structure defined over the thickness of the buffer layer.
10. The panel according to any of the previous clauses, wherein at least one buffer layer comprises at least one anisotropic material.
11. The panel according to any of the previous clauses, comprising multiple buffer layers each comprising at least one cellular structure, in particular at least one multicellular structure.
12. The panel according to clause 11, wherein the compressibility of at least one buffer layer is larger than the compressibility of at least another buffer layer.
13. The panel according to any of the previous clauses, wherein at least one buffer layer has a thickness of in the range of 3-8 mm.
14. The panel according to any of the previous clauses, wherein the at least one top layer has a Shore D hardness in the range of 60-90, more preferably in the range of 70-85.
15. The panel according to any of the previous clauses, wherein at least one top layer has a modulus of elasticity up to 5,500 MPa according to EN 310.
16. The panel according to any of the previous clauses, wherein at least one top layer has a thickness in the range of 0.05-5 mm, preferably in the range of 1 to 4.5 mm, more preferably in the range of 1.5-4 mm.
17. The panel according to any of the previous clauses, wherein the panel has a G-max of less than 120 G and/or an HIC of less than 800 when tested to ASTM F1292.
18. The panel according to any of the previous clauses, wherein at least one top layer comprises at least one polymer material and preferably at least one mineral filler, a multitude of plies of resin impregnated paper or at least one cellulose-based material chosen from at least one wood veneer and/or at least one bamboo veneer.
19. The panel according to any of the previous clauses, wherein at least one top layer has an average density of at least 1000 kg/m3, preferably at least 1200 kg/m3, more preferably at least 1400 kg/m3.
20. The panel according to any of the previous clauses, wherein the panel comprises at least one pair of opposite side edges which are provided with interconnecting coupling parts for interconnecting adjacent panels.
21. The panel according to any of the previous clauses, wherein at least one core layer is a composite core layer comprising at least 60 wt % of at least one mineral material and comprising at least one binder.
22. The panel according to any of the previous clauses, wherein at least one core layer has a density of at least 1200 kg/m3, preferably at least 1400 kg/m3.
23. The panel according to any of the previous clauses, wherein at least one core layer has a rigidity below 3,500 MPa, preferably below 2,000 MPa according to EN 310.
24. The panel according to any of the previous clauses, wherein at least part of an upper surface of at least one core layer and/or wherein at least part of a lower surface of at least one core layer comprises a plurality of cavities.
25. The panel according to any of the previous clauses, wherein the at least one core layer has a thickness in the range of 2 to 20 mm.
26. The panel according to any of the previous clauses, comprising at least one reinforcing layer, wherein at least one reinforcing layer is situated between at least one top layer and at least one buffer layer.
27. Floor covering comprising multiple panels according to any of the previous clauses.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A floor, wall, ceiling or building panel, comprising:
at least one core layer;
at least one top layer; and
at least one buffer layer situated between the at least one core layer and the at least one top layer,
wherein the at least one buffer layer comprises at least one cellular structure, and
wherein at least one top layer has a Shore D hardness in the range of 60-90 and a flexibility of 50 mm-350 mm in a Mandrel test according to ASTM F137.

2. The panel according to claim 1, wherein the at least one buffer layer comprises at least one multicellular structure chosen from the group of a hexagonal structure, honeycomb structure, a twinwall structure, a corflute construction, a foamed structure, a lattice structure or combinations thereof.

3. The panel according to claim 1, wherein the at least one buffer layer comprises at least one multicellular structure comprising a 2.5-dimensional architected material which is a 2.5-dimensional continuous lattice configuration formed by n folding points and p cell walls repeated at least once in at least one axis.

4. The panel according to claim 1, wherein the at least one buffer layer comprises at least one multicellular structure comprising a 3-dimensional architected material which is a 3-dimensional lattice configuration formed by n nodes and p struts repeated at least once in at least 2 axes.

5. The buffer layer according to claim 3, wherein the 2.5-dimensional architected material and/or 3-dimensional architected material is buckling-oriented, bending-dominated and/or has a Maxwell's Number of ≤0, preferably ≤−2, most preferably ≤−4.

6. The panel according to claim 3, wherein the 2.5-dimensional and/or 3-dimensional architected material is chosen from the group of a hexagonal lattice structure, origami structure, folded structure and/or pentamode metamaterials.

7. The panel according to claim 3, wherein at least part of the struts and/or cell walls comprise at least one folding point.

8. The panel according to claim 1, wherein the at least one buffer layer comprises at least one cellular structure comprising a gradient discrete structure, a gradient increasing structure and/or gradient decreasing structure defined over the thickness of the at least one buffer layer.

9. The panel according to claim 1, wherein at least one buffer layer comprises at least one anisotropic material.

10. The panel according to claim 1, comprising multiple buffer layers each comprising at least one cellular structure.

11. The panel according to claim 1, wherein the at least one buffer layer has a thickness of in the range of 3-8 mm.

12. The panel according to claim 1, wherein the at least one top layer has a Shore D hardness in the range of 70-85.

13. The panel according to claim 1, wherein the at least one top layer has a modulus of elasticity up to 5,500 MPa according to EN 310.

14. The panel according to claim 1, wherein the at least one top layer has a thickness in the range of 0.05-5 mm or in the range of 1.5-4 mm.

15. The panel according to claim 1, wherein at least one top layer comprises at least one polymer material and preferably at least one mineral filler, a multitude of plies of resin impregnated paper or at least one cellulose-based material chosen from at least one wood veneer and/or at least one bamboo veneer.

16. The panel according to claim 1, wherein the at least one core layer is a composite core layer comprising at least 60 wt % of at least one mineral material and comprising at least one binder.

17. The panel according to claim 1, wherein the at least one core layer has a density of at least 1200 kg/m3 and/or a rigidity below 3,500 MPa according to EN 310.

18. The panel according to claim 1, wherein at least part of an upper surface of the at least one core layer and/or wherein at least part of a lower surface of the at least one core layer comprises a plurality of cavities.

19. The panel according to claim 1, comprising at least one reinforcing layer, wherein the at least one reinforcing layer is situated between the at least one top layer and the at least one buffer layer.

20. Floor covering comprising multiple panels according to claim 1.
